(19) United States
(12) Patent Application Publication
(10) Pub. No.: US 2004/0083278 A1
(43) Pub. Date: Apr. 29, 2004

(54) Network having a number of nodes, and nodes for a network of this type

(75) Inventor: Werner Becherer, Hemhofen (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/620,357

(22) Filed: Jul. 17, 2003

Related U.S. Application Data
(63) Continuation of application No. PCT/DE02/00080, filed on Jan. 14, 2002.

(30) Foreign Application Priority Data
Jan. 17, 2001 (DE) 10101805.3

(51) Int. Cl. G06F 15/177; G06F 11/00

(52) U.S. Cl. 709/221; 709/222; 714/10

(57) ABSTRACT

A network having a plurality of nodes (A-D) in which node-specific data for parameterizing and/or configuring a first one of the nodes (B1) is stored in a second one of the nodes (C1) of the network. Operation intervention by a user is unnecessary when replacing or repairing the first node (B1) since the node-specific data can be transmitted from the second node (C1) to the first node (B1). A node is preferably a measuring transducer including a sensor and a microprocessor. The measuring transducer also includes a memory for application programs and parameter values. The measuring transducer communicates with the network via an interface. The parameters may contain characteristics of the sensor and the network configuration of nodes.

This is a Continuation of International Application PCT/DE02/00080, with an international filing date of Jan. 14, 2002, which was published under PCT Article 21(2) in German, and the disclosure of which is incorporated into this application by reference.

### FIELD OF AND BACKGROUND OF THE INVENTION

The invention relates to a network with a plurality of nodes that are interconnected via a communications channel. The invention further relates to nodes for such a network. Nodes can, for example, be switches, stored-program controllers, PCs or measuring transducers, etc.

German Utility Model 297 14 517.7 discloses a measuring transducer connected as a node to a network that has a plurality of nodes via a communications interface. A microprocessor is integrated into the measuring transducer to preprocess signals detected by a sensor at a measuring location. A processing program of the microprocessor is adapted to the respective measuring task with numerous parameters. For example, zero point and measuring span, damping or the output signal in case of a fault, as well as the characteristic of the measuring transducer are entered as parameters. After the data has been entered it is stored electronically in the measuring transducer. In addition to this data for parameterizing the measuring transducer, other node-specific data related to the configuration of the network must be stored in the node so that the measuring transducer can be operated as a node in the network and can exchange data with the other nodes via the communications channel of the network.

A problem with electronically storing data in the measuring transducer itself is that, in the event of an equipment fault, the data may not be retrievable on the measuring transducer. To make the data nevertheless accessible directly at the installation site of the measuring transducer if a defective measuring transducer is exchanged or replaced, the housing of the measuring transducer is provided with a sealed space in which an information carrier can be stored with the data. The information carrier contains all the node-specific data required to operate the node in the network. To read in the data, the information carrier can be inserted directly into a replacement device. In another embodiment, the information carrier is inserted into a programming device that transmits the node-specific data via a communications interface to the replacement device.

The use of such an information carrier has the drawback that it represents an additional cost compared to the components required for the actual operation of the measuring transducer. Additionally, careful data management is necessary to ensure that the data on the information carrier is always current. Furthermore, the error potential connected with the importing of data from the information carrier to the replacement device is significant and thus can lead to errors—especially when the operators have little training or are in stress situations, e.g. when a system is down.

### OBJECTS OF THE INVENTION

Objects of the invention include providing a network with a plurality of nodes, as well as nodes for such a network, which allow a defective node to be repaired or to be replaced by a new node in the network in a simplified manner. Other objects of the invention entail providing a network and nodes for the network, which allow a node to be repaired or to be replaced without requiring operator intervention to store the node-specific data anew in the repaired node or in the replacement node.

### SUMMARY OF THE INVENTION

According to one formulation of the invention, these and other objects are attained by a novel network having a plurality of nodes and a communications channel interconnecting the nodes for data exchange between the nodes. At least a first of the nodes is parameterized and/or configured by storing node-specific data; and at least a second of the nodes includes a memory in which the node-specific data for parameterizing and/or configuring the first node are stored. The first node is adapted to transmit the stored node-specific data to the second node when it is newly connected to the network. The second node is adapted to store the transmitted node-specific data of the first node in the memory of the second node and to transmit the node-specific data via the communications channel to the first node, for reparameterizing and/or reconfiguring the first node, if the first node is replacing a replaced node or is resuming operation.

The invention is further directed to nodes for such a network, as well as to advantageous refinements and alternate formulations of the overall inventive concept. For instance, the invention also encompasses a method that includes: storing data specific to a first node in a second node of a network of nodes interconnected by a communications channel; transmitting the data from the second node to the first node in response to an event; and utilizing the transmitted data in the first node to render the first node operational in the network.

The invention has an important advantage in allowing replacement devices to be parameterized and/or configured with the node-specific data of the failed device practically without manual entries or operator intervention. Until now, replacement devices had to be configured manually or by operator intervention prior to startup by using the above-described information carrier to adapt them to become individual nodes in the network. In cases where the time required or the potential for errors caused thereby was not tolerable, preconfigured replacement nodes had to be kept available for the exchange. This “cold standby”, however, resulted in twice the equipment cost. In the novel network, the manner of parameterization and/or configuration according to the invention avoids these supplemental costs and dramatically reduces the potential for operator errors.

If the first and second nodes in the network are adjacent nodes, especially with point-to-point connections between the nodes, the communications load of the network is minimized when a defective node is replaced, and each neighboring node knows which node is connected to its port at any given moment. In addition, using auto topology detection methods, e.g., using the “CINeMa Auto Topology” program, the replacement device can always recognize which node is the neighboring node in the network at any given moment and has stored the node-specific data of the respectively replaced network node.

Preferably, up-to-date node-specific data is always available in, specifically, the respectively adjacent node. This is achieved if the nodes in the network are configured to transmit their node-specific data to the neighboring nodes whenever this data changes, so that their memory contents are thereby updated.

The node that has been connected to the network as a replacement of a node of the same type, or the node whose operability has been restored after failure, requests transmission of the node-specific data for its reparameterization and/or reconfiguration from the neighboring node via the communications channel. This advantageously enables an automatic startup after node failure or replacement.

### BRIEF DESCRIPTION OF THE DRAWINGS

The invention and its embodiments and advantages will now be described in greater detail, by way of example, with reference to the embodiments depicted in the drawings in which:

FIG. 1 shows a network with distributed storage of node-specific data, in accordance with the invention,

FIG. 2 shows a network according to FIG. 1 with communications following node replacement,

FIG. 3 shows a network with storage of the node-specific data in a central node,

FIG. 4 shows the communications in the network according to FIG. 3 following replacement of a defective node, and

FIG. 5 is a block diagram of one embodiment of a node.

### DETAILED DESCRIPTION OF THE PREFERRED EMBODIMENTS

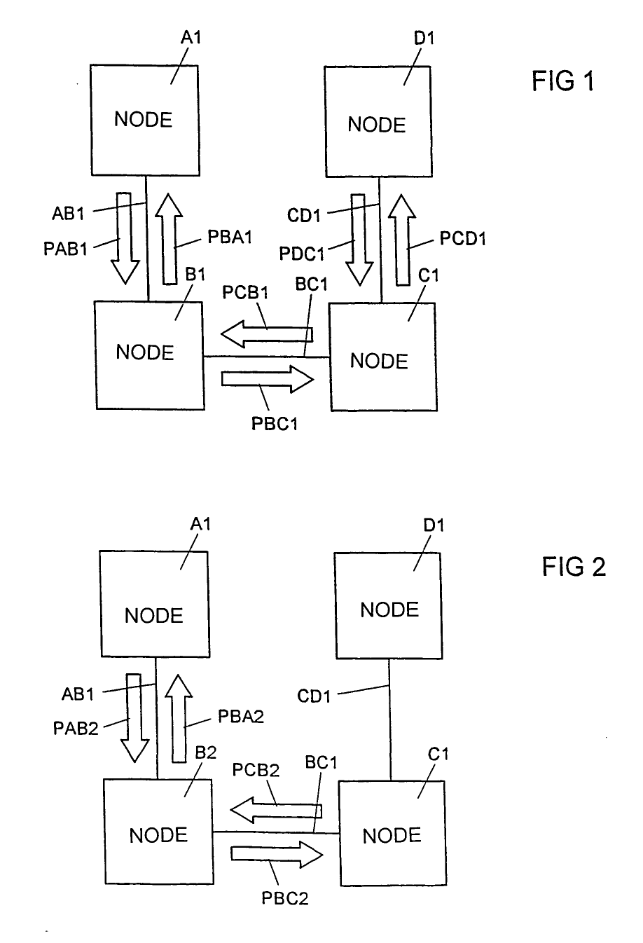

In the embodiment shown in FIG. 1, nodes A1, B1, C1 and D1 are connected to each other by signal lines AB1, BC1 and CD1. The lines AB1, BC1 and CD1 as well as the circuit elements provided for communication in the nodes A1, B1, C1 and D1 form a communications channel, e.g., according to the Ethernet standard. As an alternative to the embodiment shown, the invention can also be used in networks that meet other network specifications. In the depicted Ethernet network, the nodes A1, B1, C1 and D1 are interconnected using point-to-point connections.

When the network is first started up, the nodes send messages to their neighboring nodes with their node-specific data, which is stored in an internal memory for their own parameterization and/or configuration. The receiving node also stores this data in an internal memory provided for this purpose. The node A1 thus sends its node-specific data to the node B1 via the line AB1, as indicated by the arrow PAB1. The node B1 in turn sends its node-specific data to the node A1 according to an arrow PBA1 and to the node C1 according to an arrow PBC1. Likewise, the node C1 sends its node-specific data to the nodes B1 and D1 as indicated by arrows PCB1 and PCD1 in FIG. 1. An arrow PDC1 indicates the transmission of the node-specific data of the node D1 to the node C1. The respectively adjacent nodes store the received node-specific data of the corresponding sender.

To ensure that the node-specific data in the memories of the neighboring nodes always correspond to the most recent version of a node, that node sends new messages with its node-specific data to its neighbors whenever a change or correction is made. For example, if a parameter of the node B1 is changed by an operator action, that node again sends its node-specific data as indicated by the arrows PBA1 and PBC1 to the nodes A1 and C1, which store this data in their respective memories, together with, if appropriate, a corresponding version identification.

If, for example, the node A1 fails because of a technical defect, this node can be readily replaced by a new node of the same type. Following the request of the node A1, the node B1 returns the node-specific data of the node A1 for A1's parameterization and/or configuration. More particularly, the node B1 receives this request from a node that has been newly connected to the network and, after connection, has taken the place of the previous node A1. Alternatively, the request may be sent by the original node A1 to the node B1 if and when the operability of the original node A1 has been restored following a failure. The request is transmitted to the node B1 with the first cold restart of the node. This ensures automatic startup after failure or replacement of a node in the network.

As an alternative to the transmission of node-specific data upon request by a replacement node or a repaired node, the node-specific data can also be transmitted cyclically via the network by the respective neighboring node. This, however, involves a reduction of the transmission capacity of the network.

The behavior of a replacement node B2 after replacement of a failed node B1 will now be described with reference to FIG. 2. Like parts are identified by like reference numerals in FIG. 1 and FIG. 2. To request the transmission of its node-specific data, the new node B2 sends “get parameters” messages to its neighboring nodes A1 and C1 as indicated by arrows PBA2 and PBC2. These nodes A1 and C1 each send a message with the node-specific data of the previous node B1 to the replacement node B2 as indicated by arrows PAB2 and PCB2. The new node B2 uses the latest version of the node-specific data for its reparameterization and/or reconfiguration when cold restarted. Thereafter, the network is fully functional again without any additional operator actions.

Since a replacement device or an old repaired device does not initially know its own identity, the request for transmission of the node-specific data for its reparameterization and/or reconfiguration can be sent to the respective neighbor as a non-specific “get parameters” message. The neighbor or neighbors knows or know the identity of the failed node and provide the node-specific data for reparameterization and/or reconfiguration by transmitting corresponding messages. If several data records are provided, the most recent version is used for the cold restart.

As an alternative to the described embodiment, there may also be nodes in the network which use the services of the neighbors but which themselves do not have any storage means. For example, if such a node is located in the place of the node A1 shown in FIG. 1, the transmission of the node-specific data of the node B1 to the node A1 is rejected by returning a “reject parameters” message. If the node B1 fails during subsequent operation, only the neighboring node C1 can transmit the node-specific data to the node B1, which uses this data for its cold restart.

As an alternative to the network described above with reference to FIG. 1, the network can also be configured in such a way that each node forwards its respective knowledge of the network, including its own node-specific information, to its neighboring nodes. In this case, for example, the node B1 shown in FIG. 1 would supplement by its own node-specific data a message received from the node A1 with A1's node-specific data and forward this message to the neighboring node C1. Correspondingly, the node C1 forwards the received node-specific data of the nodes A1 and B1, again supplemented by its own node-specific data, to the node D1. The node D1 completes the received data by its own node-specific data and returns the message thus formed to the node C1, which forwards it to the node B1. The node B1 sends the complete data to the node A1. This generates in each node of the network a complete network image with the node-specific data of all the nodes. A cold restart is thus possible even in cases where several nodes are replaced simultaneously by new nodes of the corresponding type.

In this network, too, it is possible to use nodes with a lower storage capacity. These nodes store only their own node-specific data for their own parameterization and/or configuration. They supplement messages containing the network image by their own node-specific data and forward them to the neighboring nodes without storing the node-specific data of the remaining nodes connected to the network in their internal memory.

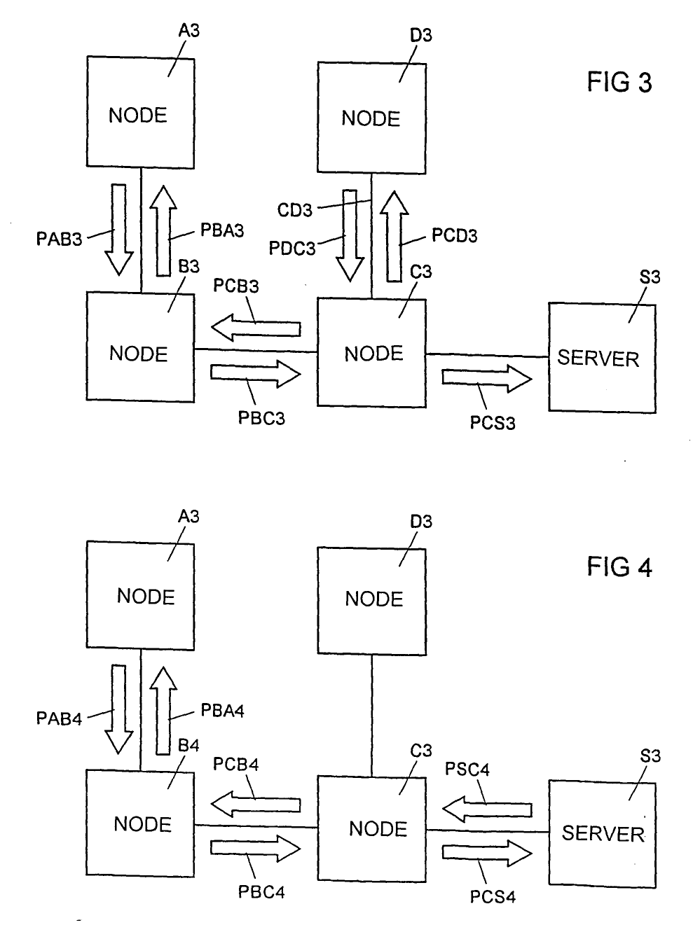

FIG. 3 shows an example where the node-specific data of all the nodes in the network are stored in a central server S3. The server S3 is connected to a port of a node C3. The node C3 with two other ports is connected to a node D3 and a node B3. The node B3 in turn is connected to a node A3. When the network is started up, the node A3 according to an arrow PAB3 sends its node-specific data in a message to the node B3, which forwards this data via the node C3 to the server S3, as indicated by arrows PBC3 and PCS3. Likewise, the node-specific data of the node B3 is forwarded via the node C3 to the server S3 as indicated by arrows PBC3 and PCS3. In addition, the node B3 sends its node-specific data to the node A3, as illustrated by an arrow PBA3. The node C3 sends messages with its node-specific data to the node B3 as well as the node D3 and to the server S3 according to arrows PCB3, PCD3 and PCS3. The node D3, finally, transmits its node-specific data via the node C3 to the server S3 as illustrated by arrows PDC3 and PCS3. After startup, the node-specific data of all the nodes A3, B3, C3 and D3 is thus stored in the server S3. The node-specific data can be transmitted to the server S3 in the described manner both online and offline, i.e., in a separate archiving step.

Node-specific data of neighboring nodes can of course be stored in each of the nodes A3, B3, C3 and D3. It is also possible to store the complete network image in the nodes. In principle, however, in the embodiment shown in FIG. 3, it is sufficient if the individual nodes store only the identity of their neighboring nodes. To characterize the identity, the IP address or a TAG may be used. The characterization must be unique in the system.

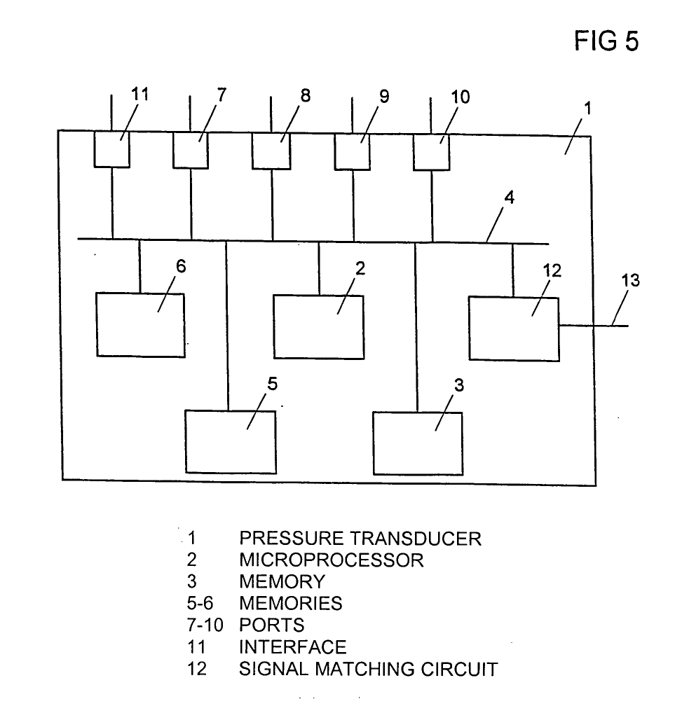

FIG. 4 shows the network according to FIG. 3 in which the node B3 was replaced with a new node B4 after a defect. Like parts are identified with like reference numerals in FIGS. 3 and 4. Since the new node B4 does not initially know its own identity, it addresses “get parameters” messages to its neighboring nodes A3 and C3, as shown by arrows PBA4 and PBC4. The two nodes A3 and C3 each transmit the identity of the earlier node B3 valid in the network to the newly connected node B4. In FIG. 4, this is illustrated by arrows PAB4 and PCB4. The replacement node B4 now has a unique identity in the network. Using this identity, the node B4 addresses a message to request the transmission of its node-specific data for its reparameterization and/or reconfiguration to the neighboring nodes A3 and C3. The node C3 forwards this request message to the server S3 as indicated by arrow PCS4. The server S3 then returns the node-specific data that it had stored for the previous node B4 to the new node B4 via the node C3. In FIG. 4 this is illustrated by arrows PSC4 and PCB4. The replacement node B4 uses the received node-specific data for reparameterization and/or reconfiguration during its cold restart. The network is thus again ready for operation.

FIG. 5 shows the basic structure of a network node using the example of a pressure transducer 1, which can be used e.g., as node B1 . . . B4 in one of the networks depicted in FIGS. 1 to 4. The central component of the pressure transducer is a microprocessor 2, which executes a program stored in a memory 3 for the application and communication software of the transducer 1. The different processor-controlled components are connected with each other by an internal bus 4. For the parameterization and configuration of the transducer 1 as a node in a network, the transducer's own node-specific data is stored in a memory 5. A memory 6 is provided for node-specific data of other nodes of the network. Four ports 7, 8, 9 and 10 are used for communication with other nodes of a network. Another network node can be connected to one of these ports by a point-to-point connection. Using the communications software stored in the memory 3 and the configuration data stored in the memory 5 the transducer determines the forwarding of incoming messages or sends its own messages. The communications software ensures that when the transducer 1 is used as a replacement device, the transducer's own node-specific data and the node-specific data of other nodes connected to the network is written into the memories 5 and 6 as described above. As an alternative thereto, it is also possible, however, to parameterize and/or configure the transducer 1 manually by connecting a control unit—not shown in FIG. 5 for the sake of clarity—to a communications interface 11 or to one of the ports 7 . . . 10. A further component of the measuring transducer 1 is a pressure sensor, with a signal matching circuit 12 provided, to which a medium having the pressure to be measured is coupled through a line 13.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof

What is claimed is:

1. Network comprising:
a plurality of nodes; and
a communications channel interconnecting the nodes for data exchange between the nodes;
wherein at least a first of the nodes is at least one of parameterized and configured by storing node-specific data;
wherein at least a second of the nodes comprises a memory in which the node-specific data, for the at least one of parameterizing and configuring the first node, are stored;
wherein the first node, when newly connected to the network, is adapted to transmit the stored node-specific data to the second node; and
the second node is adapted to store the transmitted node-specific data of the first node in the memory of the second node and to transmit the node-specific data via the communications channel to the first node, for at least one of reparameterizing and reconfiguring the first node, if the first node is replacing a replaced first node or is resuming operation.

2. Network as claimed in claim 1, wherein the first node and the second node are adjacent in the network.

3. Network as claimed in claim 1, wherein the first node is adapted to transmit changes in the node-specific data to the second node, in order to update memory contents.

4. Network as claimed in claim 1, wherein the first node is adapted to request, when cold restarted after the first node has been connected to the network as a replacement of a node of a same type or after operability of the first node has been restored following a failure, that the second node transmit the node-specific data to the first node, for the at least one of reparameterizing and reconfiguring the first node, via the communications channel.

5. Node for a network having a plurality of nodes and a communications channel interconnecting the nodes, wherein:
the node is adapted to be at least one of parameterized and configured by storing node-specific data,
the node is adapted, when newly connected to the network, to transmit the stored node-specific data to another of the plurality of nodes of the network, and
the node is adapted to request, when cold restarted after having been connected to the network as a replacement of a node of a same type or after operability of the node has been restored following a failure, that the other node transmit the node-specific data, for at least one of reparameterizing and reconfiguring the node via the communications channel.

6. Node for a network having a plurality of nodes and a communications channel interconnecting the nodes,
comprising a memory in which node-specific data for at least one of parameterizing and configuring another of the nodes are stored,
wherein the node is adapted to store in the memory received node-specific data of the other node and to transmit the received data via the communications channel to the other node for at least one of reparameterizing and reconfiguring the other node when the other node is replacing a replaced other node or is resuming operation.

7. A method comprising:
storing data specific to a first node in a second node of a network of nodes interconnected by a communications channel;
transmitting the data from the second node to the first node in response to an event; and
utilizing the transmitted data in the first node to render the first node operational in the network.

8. The method according to claim 7, wherein the event is a restart of the first node.

9. The method according to claim 7, wherein the event is a start of an inserted, functioning first node replacing a removed, defective first node.

10. The method according to claim 7, wherein the data comprise parameterization data.

11. The method according to claim 7, wherein the data comprise configuration data.

12. The method according to claim 7, further comprising transmitting the data from the first node to the second node in response to another event.

13. The method according to claim 12, wherein the other event is an update of the data specific to the first node.

14. A network comprising:
a plurality of nodes;
a communications channel interconnecting the nodes;
wherein a first of said nodes comprises:
a first memory configured to store data specific to said first node; and
wherein a second of said nodes comprises:
a second memory configured to store the data specific to said first node; and
a port configured to transmit the data specific to said first node from said second node to said first node.

15. The network according to claim 14, wherein said second node further comprises:
a third memory configured to store data specific to said second node.

16. The network according to claim 15, wherein said first node further comprises:
a fourth memory configured to store data specific to said second node.
